(19) United States
(12) Patent Application Publication
(10) Pub. No.: US 2009/0034110 A1
(43) Pub. Date: Feb. 5, 2009

(54) DISK DRIVE APPARATUS AND MULTI-TASKING METHOD

(75) Inventors: Stephen G. Paul, Santa Cruz, CA (US); Dar-Der Chang, San Jose, CA (US)

Correspondence Address: SCHWEGMAN, LUNDBERG & WOESSNER/TOSHIBA, P.O. BOX 2938, MINNEAPOLIS, MN, 55402, US

(73) Assignee: Kabushiki Kaisha Toshiba 1-1, Tokyo (JP)

(21) Appl. No.: 11/830,745

(22) Filed: Jul. 30, 2007

(51) Int. Cl. G11B 5/02

(52) U.S. Cl. 360/55

(57) ABSTRACT

A disk drive apparatus is shown that provides multi-tasking of firmware and hardware separately. A shared data structure is shown that permits queuing of multiple task requests and storing of multiple task results for later use, decreasing a need for wait time between components such as disk drive firmware and hardware. Further efficiencies are provided, including power saving modes when higher power disk drive components are not in use.

### BACKGROUND

A disk drive is an information storage device. A disk drive includes one or more disks clamped to a rotating spindle, and at least one head for reading information representing data from and/or writing data to the surfaces of each disk. The head is supported by a suspension coupled to an actuator that may be driven by a voice coil motor. Control electronics in the disk drive provide electrical pulses to the voice coil motor to move the head to desired positions on the disks to read and write the data in circular tracks on the disks, and to park the head in a safe area when not in use or when otherwise desired for protection of the disk drive.

Programs stored within a disk drive for controlling drive functions are often stored as firmware. Selected firmware is configured to multi-task, or otherwise perform more than one operation concurrently. Frequently, firmware uses disk drive hardware to obtain data that is used in one or more of the firmware multi-task operations. However, disk drive hardware is only capable of single-tasking. If a request for data from the firmware to the disk drive hardware takes a long time, the firmware may need to wait for a result from the single-tasking disk drive hardware before completing a firmware operation. A more efficient use of both firmware and disk drive hardware is desirable.

### BRIEF DESCRIPTION OF THE DRAWINGS

FIG. 1 is a perspective view of a magnetic recording and reproducing apparatus (hard disk drive) according to an example embodiment;

FIG. 2 is a schematic plan view of a magnetic disk according to an example embodiment;

FIG. 3 is a perspective view of a data zone in a magnetic disk according to an example embodiment;

FIG. 4 is a schematic diagram showing a servo zone and a data zone in a magnetic disk according to an example embodiment;

FIG. 5 is a plan view showing patterns in a servo zone and a data zone in a magnetic disk according to an example embodiment;

FIG. 6 is a block diagram of the magnetic recording and reproducing apparatus (hard disk drive) according to an example embodiment;

FIG. 7 is a block diagram of portions of a controller according to an example embodiment.

FIG. 8 is an example block diagram of a computer system for implementing methods and devices as described in accordance with example embodiments.

### DETAILED DESCRIPTION

Hereinafter, example embodiments of the present invention will be described with reference to the drawings.

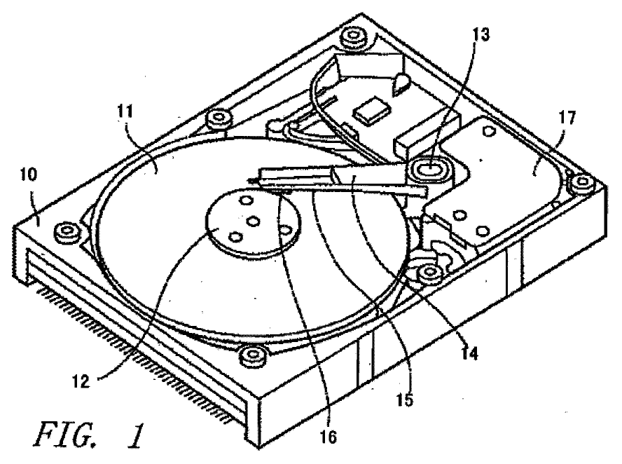

FIG. 1 is a perspective view of a magnetic recording and reproducing apparatus (hard disk drive) according to an embodiment. The magnetic recording and reproducing apparatus comprises, inside a chassis 10, a magnetic disk 11, a head slider 16 including a read head and a write head, a head suspension assembly (a suspension 15 and an actuator arm 14) that supports the head slider 16, a voice coil motor (VCM) 17 and a circuit board.

The magnetic disk (discrete track media) 11 is mounted on and rotated by a spindle motor 12. Various digital data are recorded on the magnetic disk 11 in a perpendicular magnetic recording manner. In an example embodiment, the magnetic head incorporated in the head slider 16 is an integrated head including a write head of a single pole structure and a read head using a shielded magneto resistive (MR) read element (such as a GMR film or a TMR film). The suspension 15 is held at one end of the actuator arm 14 to support the head slider 16 to face the recording surface of the magnetic disk 11. The actuator arm 14 is attached to a pivot 13. The voice coil motor (VCM) 17, which drives the actuator, is provided at the other end of the actuator 14. The VCM 17 drives the head suspension assembly to position the magnetic head at an arbitrary radial position of the magnetic disk 11. The circuit board comprises a head IC to generate driving signals for the VCM and control signals for controlling read and write operations performed by the magnetic head.

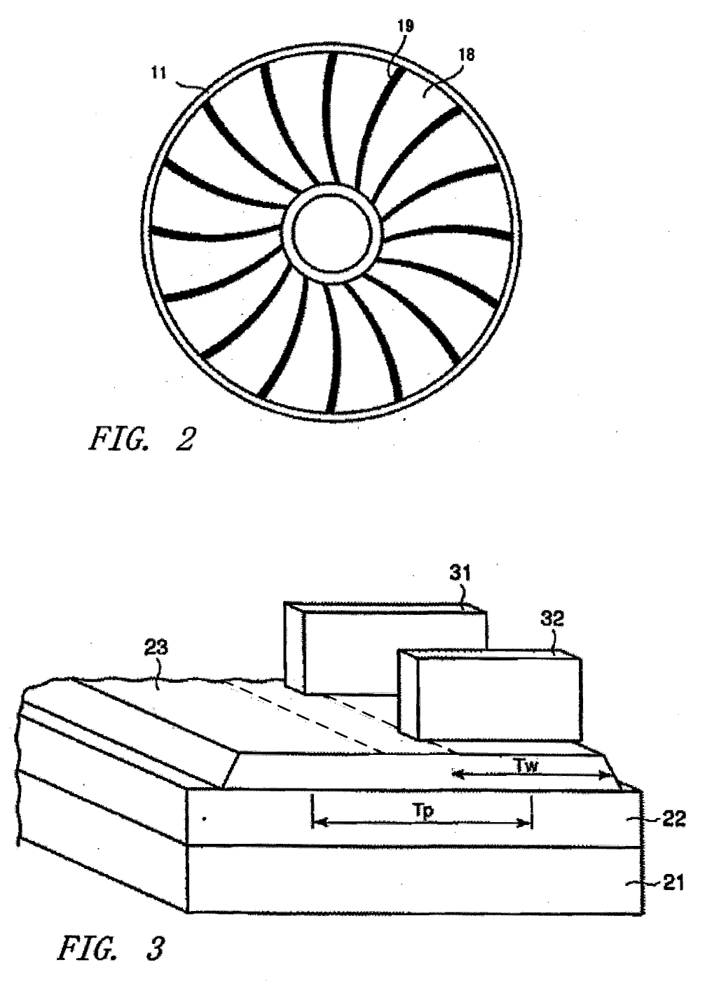

FIG. 2 is a schematic plan view of a magnetic disk 11 according to an embodiment. FIG. 2 shows data zones 18 and servo zones 19. User data is recorded in each of the data zones 18. This example magnetic disk has tracks formed of concentric magnetic patterns. The recording tracks will be described later by way of example with reference to FIG. 3. Servo data for head positioning is formed in each of the servo zones 19 as patterns of a differently magnetized material. On the disk surface, the servo zone 19 is shaped like a circular arc corresponding to a locus of a head slider during access.

FIG. 3 is a perspective view of one example of a data zone in a magnetic disk media according to an embodiment. A soft underlayer 22 is formed on a substrate 21. Magnetic patterns constituting the recording tracks 23. The radial width and track pitch of the recording track 23 are denoted as Tw and Tp, respectively. A GMR element 31 of a read head and a single pole 32 of a write head, which are formed in the head slider, are positioned above the recording track 23.

As the substrate 21, a flat glass substrate may be used. The substrate 21 is not limited to the glass substrate but an aluminum substrate (or any other suitable substrate) may be used. A magnetic material is placed onto the substrate 21 and selectively magnetized to form recording tracks. A magnetic material such as recording track 23, CoCrPt may be used, although the invention is not so limited. Although not shown, a protective film of diamond-like carbon (DLC) may be formed on the surfaces of the media. In one example, lubricant may be applied to the surface of the protective film.

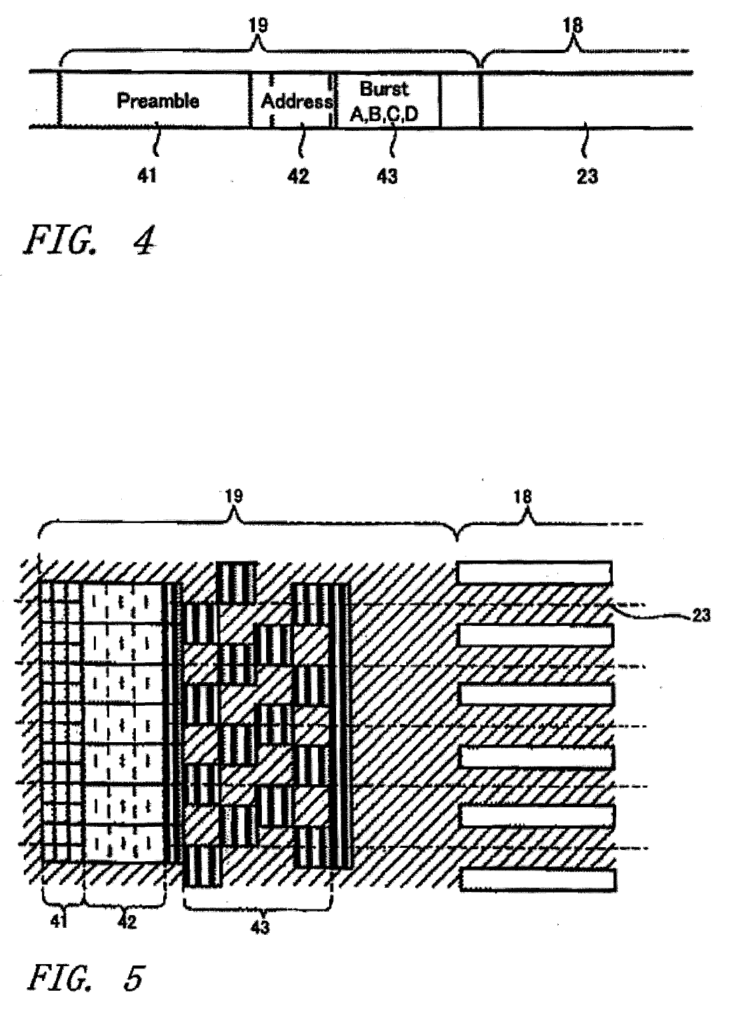

With reference to FIGS. 4 and 5, the patterns of the servo zone and data zone will be described. As schematically shown in FIG. 4, the servo zone 19 includes a preamble section 41, an address section 42, and a burst section 43 for detecting deviation.

As shown in FIG. 5, the data zone 18 includes the recording tracks 23. Patterns of the magnitization which provide servo signals are formed in each of the preamble section 41, address section 42, and burst section 43 in the servo zone 19. These sections may have the functions described below.

The preamble section 41 is provided to execute a phase lock loop (PLL) process for synthesizing a clock for a servo signal read relative to deviation caused by rotational deflection of the media, and an AGC process for maintaining appropriate signal amplitude.

The address section 42 may have servo signal recognition codes called servo marks, sector data, cylinder data, and the like formed at the same pitch as that of the preamble section 41 in the circumferential direction using encoding, for example Manchester, or other types of encoding. In particular, since the cylinder data has a pattern exhibiting a data varied for every servo track to provide the minimum difference between adjacent tracks so as to reduce the adverse effect of address reading errors during a seek operation.

The burst section 43 is an off-track detecting region used to detect the amount of off-track with respect to the on-track state for a cylinder address. The burst section 43 includes patterns to locate a read or write head with respect to a desired track center. A pattern in FIG. 5 is shown by way of example including four fields of burst marks (A, B, C, and D), whose pattern phases in a radial direction are shifted to each other in respective fields. Other burst patterns could also be used. In one example, plural marks are arranged at the same pitch as that of the preamble section in the circumferential direction.

The principle of detection of a position on the basis of the burst section 43 will not be described in detail. When using the pattern shown, the off-track amount is obtained by calculating the average amplitude value of read signals from the A, B, C, and D bursts. As discussed above, other patterns may be used that do not depend on average amplitude.

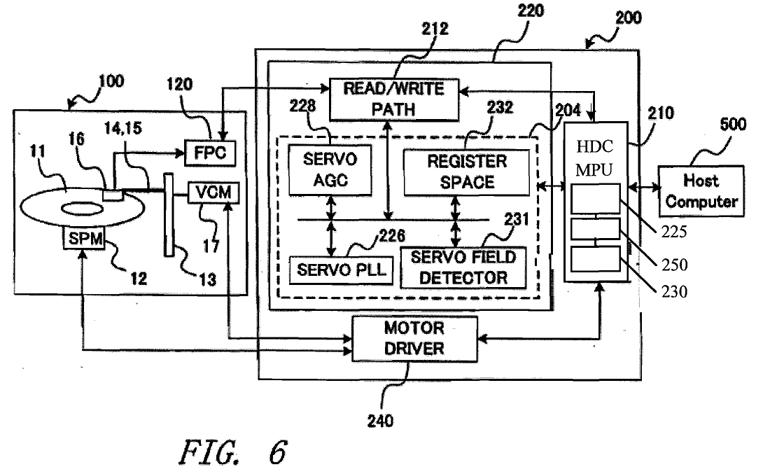

FIG. 6 shows a block diagram of a magnetic recording and reproducing apparatus (hard disk drive) according to an example embodiment. This figure shows the head slider 16 only above the top surface of the magnetic disk 11. However, the perpendicular magnetic recording layer with discrete tracks is formed on each side of the magnetic disk. A down head and an up head are provided above and below the top and bottom surfaces of the magnetic disk, respectively. The disk drive includes a main body unit called a head disk assembly (HDA) 100 and a printed circuit board (PCB) 200.

As shown in FIG. 6, the HDA 100 has the magnetic disk 11, the spindle motor 12, which rotates the magnetic disk 11, the head slider 16, including the read head and the write head, the suspension 15 and actuator arm 14, the VCM 17, and a head amplifier (HIC), which is not shown. The head slider 16 is provided with the read head including a read element 31, such as a giant magnetoresistive (GMR) element and the write head 32, which are shown in FIG. 3.

The head slider 16 may be elastically supported by a gimbal provided on the suspension 15. The suspension 15 is attached to the actuator arm 14, which is rotatably attached to the pivot 13. The VCM 17 generates a torque around the pivot 13 for the actuator arm 14 to move the head in the radial direction of the magnetic disk 11. The HIC is fixed to the actuator arm 14 to amplify input signals to and output signals from the head. The HIC is connected to the PCB 200 via a flexible cable 120. Providing the HIC on the actuator arm 14 may effectively reduce noise in the head signals. However, the HIC may be fixed to the HDA main body.

As described above, the magnetic recording layer is formed on each side of the magnetic disk 11, and the servo zones 19, each shaped like a circular arc, are formed so as to correspond to the locus of the moving head. The specifications of the magnetic disk meet outer and inner diameters and read/write characteristics adapted to a particular drive. The radius of the circular arc formed by the servo zone 19 is given as the distance from the pivot to the magnet head element.

In the illustrated example embodiment, several major electronic components, so-called system LSIs, are mounted on the printed circuit board (PCB) 200. The system LSIs are a controller 210, a read/write channel IC 220, and a motor driver IC 240. The controller 210 includes a disk controller (HDC) and an MPU, and firmware. In one embodiment, the controller 210 includes a first data processing module 225 and a second data processing module 230. A shared data structure 250 is coupled between the first data processing module 225 and the second data processing module 230 as described in more detail below.

The MPU is a control unit of a driving system and includes ROM, RAM, CPU, and a logic processing unit that implements a head positioning control system according to the present example embodiment. The logic processing unit is an arithmetic processing unit comprised of a hardware circuit to execute high-speed calculations. Firmware for the logic processing circuit is saved to the ROM or elsewhere in the disk drive. The MPU controls the drive in accordance with firmware.

The disk controller (HDC) is an interface unit in the hard disk drive which manages the whole drive by exchanging information with interfaces between the disk drive and a host computer 500 (for example, a personal computer) and with the MPU, read/write channel IC 220, and motor driver IC 240.

The read/write channel IC 220 is a head signal processing unit relating to read/write operations. The read/write channel IC 220 is shown as including a read/write path 212 and a servo demodulator 204. The read/write path 212, which can be used to read and write user data and servo data, may include front end circuitry useful for servo demodulation. The read/write path 212 may also be used for writing servo information in self-servowriting. It should be noted that the disk drive also includes other components, which are not shown because they are not necessary to explain the example embodiments.

The servo demodulator 204 is shown as including a servo phase locked loop (PLL) 226, a servo automatic gain control (AGC) 228, a servo field detector 231 and register space 232. The servo PLL 226, in general, is a control loop that is used to provide frequency and phase control for the one or more timing or clock circuits (not shown in FIG. 6) within the servo demodulator 204. For example, the servo PLL 226 can provide timing signals to the read/write path 212. The servo AGC 228, which includes (or drives) a variable gain amplifier, is used to keep the output of the read/write path 212 at a substantially constant level when servo zones 19 on one of the disks 11 are being read. The servo field detector 231 is used to detect and/or demodulate the various subfields of the servo zones 19, including a SAM, a track number, a first phase servo burst, and a second phase servo burst. The MPU is used to perform various servo demodulation functions (e.g., decisions, comparisons, characterization and the like), and can be thought of as being part of the servo demodulator 204. In the alternative, the servo demodulator 204 can have its own microprocessor.

One or more registers (e.g., in register space 232) can be used to store appropriate servo AGC values (e.g., gain values, filter coefficients, filter accumulation paths, etc.) for when the read/write path 212 is reading servo data. One or more registers can be used to store appropriate values (e.g., gain values, filter coefficients, filter accumulation paths, etc.) for when the read/write path 212 is reading user data. A control signal can be used to select the appropriate registers according to the current mode of the read/write path 212. The servo AGC value(s) that are stored can be dynamically updated. For example, the stored servo AGC value(s) for use when the read/write path 212 is reading servo data can be updated each time an additional servo zone 19 is read. In this manner, the servo AGC value(s) determined for a most recently read servo zone 19 can be the starting servo AGC value(s) when the next servo zone 19 is read.

The read/write path 212 includes the electronic circuits used in the process of writing and reading information to and from the magnetic disks 11. The MPU can perform servo control algorithms, and thus may be referred to as a servo controller. Alternatively, a separate microprocessor or digital signal processor (not shown) can perform servo control functions.

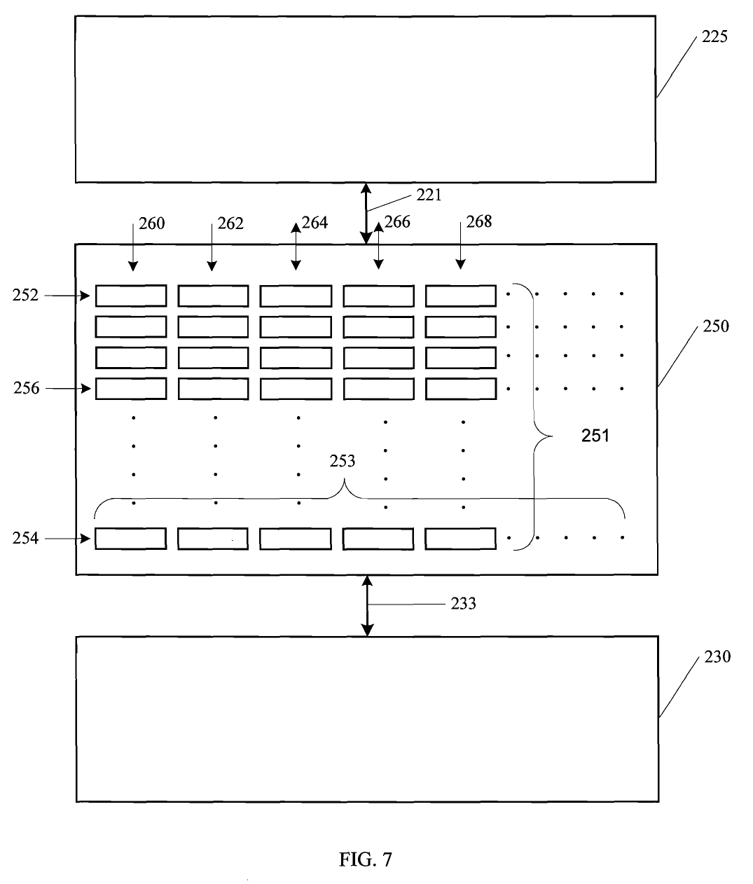

FIG. 7 illustrates portions of the controller 210 as shown in FIG. 6. As recited above, a first data processing module 225 and a second data processing module 230 are shown with a shared data structure 250. Data is exchanged between the first data processing module 225 and the shared data structure 250 as indicated by arrows 221. Likewise, data is exchanged between the second data processing module 230 and the shared data structure 250 as indicated by arrows 233.

In one embodiment, the first data processing module 225 includes programming such as firmware to perform disk drive operations such as data calculations. In one embodiment, the second data processing module 230 includes programming to perform hardware operations.

In one example device operation, firmware in the first data processing module 225 requests data for a calculation that must be retrieved using hardware. The programming in the second data processing module 230 drives the hardware such as voice coil motor, read/write head, etc. as requested to obtain the requested data. The requested data is then delivered to the firmware in the first data processing module 225 through the shared data structure 250 using channels 231 and 221.

As discussed above, in a single-tasking hardware configuration, the firmware in the first data processing module 225 waits while the hardware and the second data processing module 230 obtains the data. Embodiments using the shared data structure 250 provide improved efficiency by allowing multi-tasking on various levels.

FIG. 7 shows a plurality of tasks arranged in a queue 251 within the shared data structure 250. In the example shown, the plurality of tasks are ranked with a first task 252 in line, a number of middle tasks 256 and a last task 254. For purposes of illustration a plurality of tasks are discussed, although one of ordinary skill in the art having the benefit of the present disclosure will recognize that the queue will include any number of tasks at a given time during operation. Depending on the workload of the hard drive, the queue may include only a single task, or several tasks. If no hardware information is needed by firmware, the queue may be temporarily empty.

In an example method of operation, using the shared data structure 250, the firmware in the first data processing module 225 requests a plurality of disk drive hardware operations, without the need to wait for the results of the previous request before submitting the next request. Because a queue of hardware requests are stored, the firmware in the first data processing module 225 is able to multi task, or work on other operations while the second data processing module 230 obtains the data. In one embodiment, as the results from the hardware and the second data processing module 230 are obtained, the results are stored in memory such as RAM or other fast access memory for later use by the firmware in the first data processing module 225. Storage of the results for use when needed further allows the firmware in the first data processing module 225 to multi task independent of the second data processing module 230.

FIG. 7 further illustrates an example of a shared data structure 250 where each task in the queue 251 includes a plurality of fields 253. Although fields 253 are shown in a particular order, one of ordinary skill in the art will recognize that other orders are within the scope of the invention. In one embodiment, a first field 260 indicates a task number. The task number is used to assign a priority to the tasks in the queue 251. In one example, the first task 252 would be assigned the task number one to indicate that it is to be performed first. Following this example, a priority within the queue is determined by task numbers 1, 2, 3, etc. with the lowest number being the next task to be performed.

In one example, another field includes a data input field 262. Examples of data input include the instructions for what is to be retrieved using hardware and the second data processing module 230. In one example, another field includes a data output field 264. An example of data output includes a result of the instructions in the data input field.

Examples of functions that hardware can perform while the firmware is multitasking include address translation requests. In one example, a request from firmware includes translation request between formats such as a cylinder head sector (CHS), physical block address (PBA), logical block address (LBA), etc.

In one example, another field includes a task status field 266. An example of data in the task status field includes a flag or other indicator that the task is complete. In one example if a flag in the task status field is on, then the task is complete, and the firmware in the first data processing module 225 can retrieve results from the data output field 264. If the task status field 266 is not flagged, then the firmware in the first data processing module 225 can continue multi-tasking until the task is complete.

In one example, another field includes a pause flag 268. An example of a method using a pause flag includes pausing execution of a task if the pause flag is on. In one example, insertion of one or more tasks into the queue 251 is better accomplished if task execution is paused while additional tasks are inserted into the queue. Although a pause flag is shown as a field in each task, the invention is not so limited. Other configurations include a pause function in the shared data structure 250 or otherwise in the controller 210 that pause execution of requests while other tasks are being entered into the queue.

In one example, a device used to operate the shared data structure 250 includes multi-port RAM, although the invention is not so limited. Other memory types, and circuitry configurations to share data between multitasking modules are also within the scope of the invention.

In one example, efficiency of the controller 210 and the hard drive is enhanced by changing priority within the queue 251. In one example after a plurality of tasks are entered into the queue, a priority order is changed to reflect data that is more urgently needed by the firmware or first data processing module 225. In one example the existing queue is shuffled to reflect a changed priority of tasks in the queue 251. In one example an additional task is inserted into the queue 251 at a location other than the end of the line 254. In one example the additional task is inserted into a middle location in the queue to effectively change the order of tasks in the queue 251.

In one example additional tasks are limited to insertion at either a beginning of the line 252, or an end of the line 254. A priority of the queue 251 is therefore only changed as additional tasks are inserted. High priority tasks can be inserted at the very front of the line 252, while low priority tasks are inserted at the very end of the line. Configurations using a priority system as described above are simple to program, and require a less sophisticated configuration to operate.

In one example, efficiency of the controller 210 and the hard drive is enhanced by placing the hardware and the second data processing module 230 in a power saving mode when no tasks are within the queue 251. Multi-tasking of both the firmware and first data processing module 225 and independent operation and multitasking of the hardware and second data processing module 230 increase a benefit of a power saving mode in such a configuration. In one example, due to multi-tasking, hardware can work continuously for longer periods of useful time, and likewise move to a power saving state for longer periods of time.

Disk drives using a controller structure as described in embodiments above provides faster more efficient data access and calculation due to features such as multi-tasking of firmware and hardware separately. A shared data structure facilitates queuing of multiple task requests and storing of multiple task results for later use, thus decreasing wait time between modules. Further efficiencies are provided using features such as power saving modes when higher power drain devices such as voice coil motors, etc. are not needed.

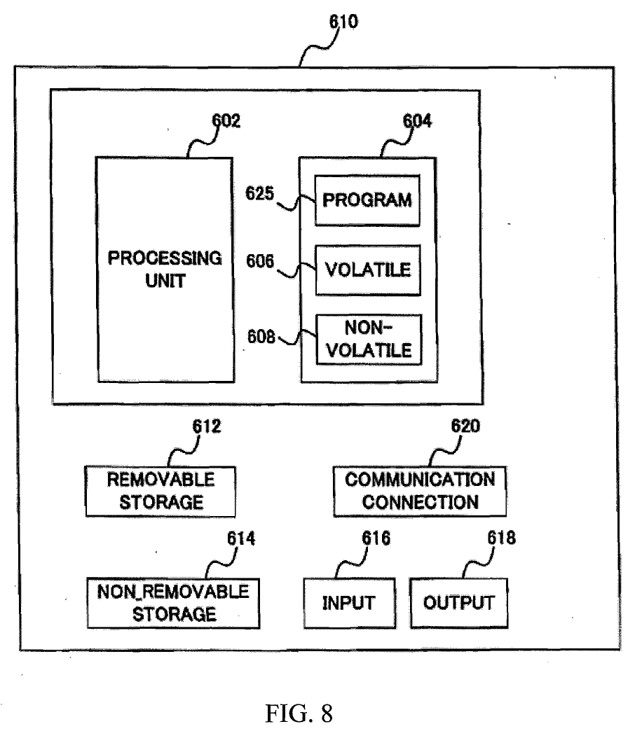

A block diagram of a computer system including selected embodiments of disk drives and controllers as described above is shown in FIG. 8. A general computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. The controller 210 or other selected circuitry or components of the disk drive may be such a computer system.

Computer-readable instructions stored on a computer-readable medium are executable by the processing unit 602 of the computer 610. A hard drive, CD-ROM, and RAM are some examples of articles including a computer-readable medium. The computer program may also be termed firmware associated with the disk drive. In some embodiments, a copy of the computer program 625 can also be stored on the magnetic disk 11 of the disk drive.

Although a computer 610 is used as an example, other devices including hard drives such as portable music players, digital video recorders, etc. are within the scope of the invention. The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method, comprising:
receiving a plurality of requests for disk drive hardware operations from disk drive firmware;
storing the plurality of requests in a prioritized order;
utilizing the disk drive hardware to complete the plurality of requests in the prioritized order; and
performing one or more disk drive firmware operations while the disk drive hardware works to complete the plurality of requests.

2. The method of claim 1, wherein storing the plurality of requests in the prioritized order includes storing the plurality of requests in an order in which the requests were received.

3. The method of claim 1, wherein storing the plurality of requests in the prioritized order includes changing an order of the plurality of requests to an order different from an order in which the requests were received.

4. The method of claim 1, further including storing one or more results of the plurality of requests in a memory location until the results are retrieved by the disk drive firmware.

5. The method of claim 1, wherein receiving the plurality of requests for disk drive hardware operations includes receiving at least one address translation request.

6. The method of claim 5, wherein receiving at least one address translation request includes receiving a request to translate between address formats chosen from a list consisting of cylinder head sector (CHS); physical block address (PBA); and logical block address (LBA).

7. The method of claim 1, further including placing the disk drive hardware in a power saving mode when no requests for disk drive hardware operations are pending.

8. A method, comprising:
sending a plurality of data requests from a disk drive firmware to a disk drive hardware to form a list of pending data requests;
changing a prioritized order of the list;
using disk drive hardware to perform the plurality of requests in the prioritized order; and
delivering resulting data to the firmware.

9. The method of claim 8, wherein changing the prioritized order of the list includes inserting an additional data request into the list.

10. The method of claim 9, wherein inserting the additional data request into the list includes inserting an additional data request at a beginning of the list.

11. The method of claim 8, wherein sending the plurality of data requests from the disk drive firmware to the disk drive hardware to form the list of pending data requests includes prioritizing requests by sending the data requests to either a beginning of the list or an end of the list.

12. The method of claim 8, further including pausing execution of a next data request in the list until the disk drive firmware has completed changing the prioritized order of the list.

13. The method of claim 8, wherein delivering the data to the disk drive firmware includes storing the data in a shared data structure for later access by the disk drive firmware.

14. The method of claim 8, wherein sending the plurality of data requests includes sending at least one request to translate between address formats chosen from a list consisting of cylinder head sector (CHS); physical block address (PBA); and logical block address (LBA).

15. A disk drive apparatus, comprising:
a first data processing module to perform a first set of disk drive operations;
a second data processing module to perform a second set of disk drive operations independent from the first set of disk drive operations and at least partially at a same time as the first set of disk drive operations; and
a shared data structure between the first data processing module and the second data processing module to store data including:
a plurality of requests for the second set of disk drive operations in a prioritized order;
a plurality of results of the second set of disk drive operations to be used by the first data processing module.

16. The disk drive apparatus of claim 15, wherein first data processing module is configured to perform firmware operations and the second data processing module is configured to perform hardware operations.

17. The disk drive apparatus of claim 15, wherein the shared data structure includes a priority ranking field for each of the plurality of requests.

18. The disk drive apparatus of claim 17, wherein the shared data structure includes a data input field and a data output field.

19. The disk drive apparatus of claim 18, wherein the shared data structure includes a disk drive operation status field.

20. The disk drive apparatus of claim 15, wherein the shared data structure utilizes multi-port random access memory (RAM) within the disk drive apparatus.
